(19) United States
(12) Patent Application Publication
(10) Pub. No.: US 2011/0129653 A1
(43) Pub. Date: Jun. 2, 2011

(54) Protection structure to printed layer of plastic film

(75) Inventor: Cheng-Yi Yang, Taipei (TW)

(73) Assignee: Lung Fa Sports Industrial Co., Ltd.

(21) Appl. No.: 12/591,667

(22) Filed: Nov. 27, 2009

(51) Int. Cl. B32B 7/12; B32B 3/10

(52) U.S. Cl. 428/200; 428/201

(57) ABSTRACT

A plastic film includes a first plastic layer, a printed layer connected to an inside of the first plastic layer, and a second plastic layer is then connected to the inside of the first plastic layer to sandwich the printed layer between the first and second plastic layers, wherein a glue layer is applied between the first and second plastic layers and the first and second plastic layers are connected to each other by way of high frequency heating or ultrasonic heating. The printed layer is protected by the first and second layers and avoided from scrubbed. The plastic film can be used as stationery bag or cosmetic bag.

### BACKGROUND OF THE INVENTION

(1) Field of the Invention

The present invention intends to provide a plastic film which can protect the printed layer from being damaged and effectively improves the shortcomings of the conventional plastic film.

(2) Description of the Prior Art

A conventional product with plastic film such as stationery bag or cosmetic bag, or leather covered bag, generally includes printed patterns to have better aesthetic appearance, better quality of touch or even appealing advertisement feature. The printed patterns are printed directly to the outer surface of the plastic film. However, the printed patterns can be easily peeled off from the plastic film, faded by impact, scrubbing or exposure of light. This affects appearance of the product and needs to be improved.

### SUMMARY OF THE INVENTION

The present invention relates to a plastic film which includes a first plastic layer, a printed layer connected to an inside of the first plastic layer, and a second plastic layer connected to the inside of the first plastic layer to sandwich the printed layer between the first and second plastic layers. The first plastic layer is made of Polyethylene Terephthalate and the second plastic layer is made of Polyvinylchoride. A glue layer is applied between the first and second plastic layers, and the first and second plastic layers are connected to each other by way of high frequency heating or ultrasonic heating.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the layers of the plastic film of the present invention;

FIG. 2 is a cross sectional view of the plastic film of the present invention, and

FIG. 3 is a perspective view to show that the plastic film of the present invention is used as a stationery bag.

### DETAILED DESCRIPTION OF THE PREFERRED EMBODIMENTS

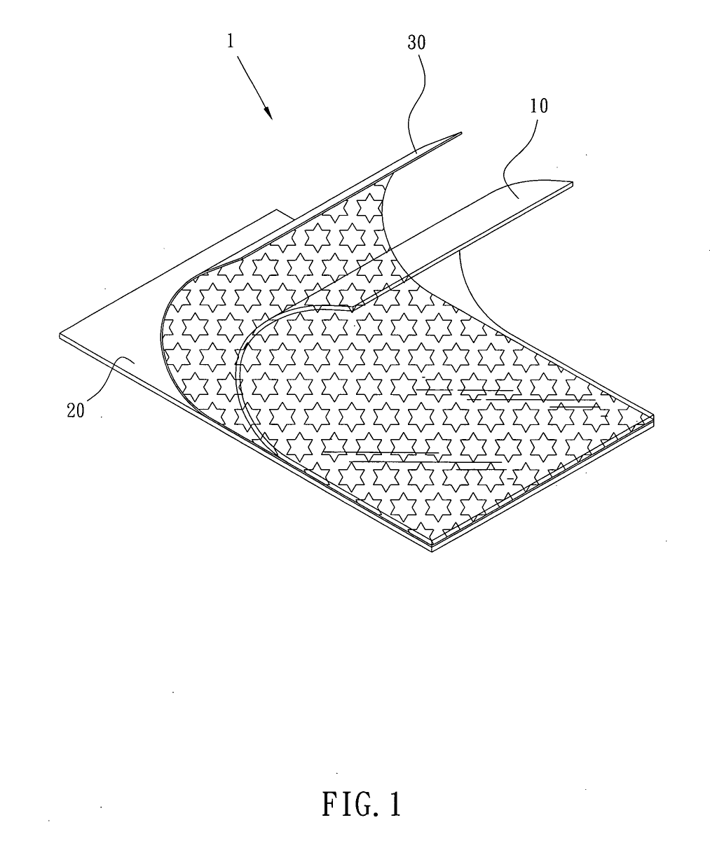

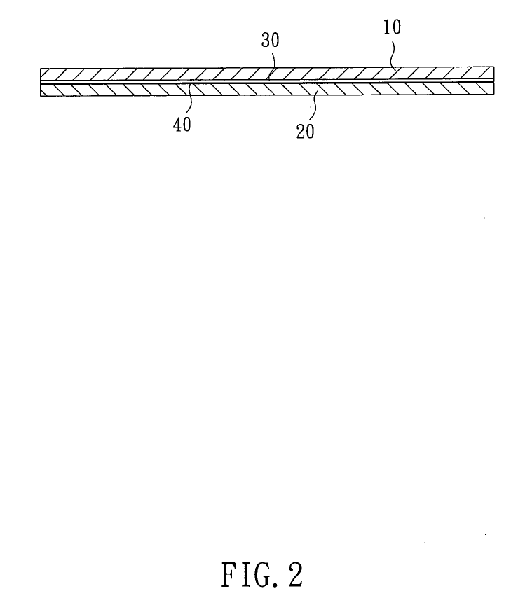

Referring to FIGS. 1 to 3, the plastic film 1 of the present invention comprises a first plastic layer 10, a second plastic layer 20 and a printed layer 30. The plastic film can be made to be a stationery bag or a cosmetic bag, or a leather covered bag. In this embodiment, the plastic film 1 of the present invention is made to be a stationery bag.

The first plastic layer 10 is made of Polyethylene Terephthalate and the second plastic layer 20 is made of Polyvinylchoride such that the printed layer 30 is connected to an inside of the first plastic layer 10.

When assembling, a glue layer 40 is applied between the first and second plastic layers 10, 20, and the first and second plastic layers 10, 20 are connected to each other by way of high frequency heating or ultrasonic heating.

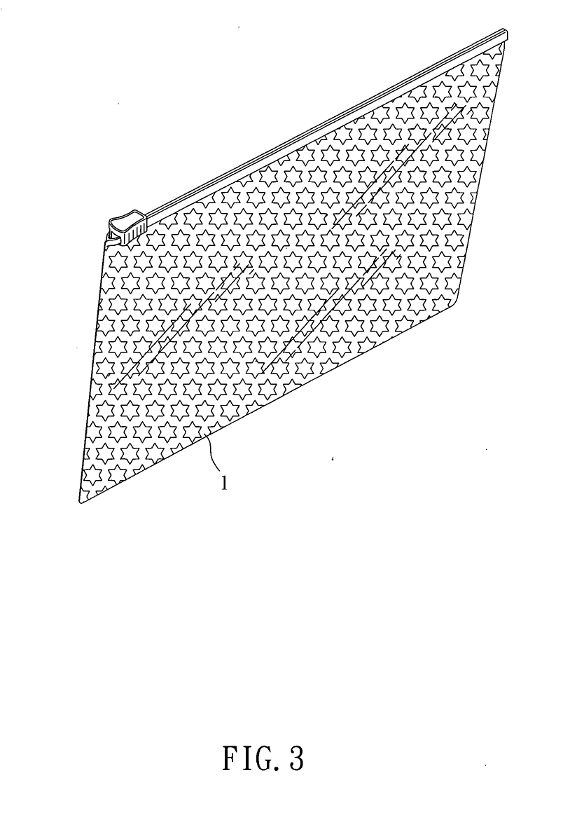

As shown in FIG. 3, the printed layer 30 is located between the first and second plastic layers 10, 20 and protected by the first and second plastic layers 10, 20 such that the printed layer 30 does not scrubbed or fade to keep the product as new for a long period of time.

While we have shown and described the embodiment in accordance with the present invention, it should be clear to those skilled in the art that further embodiments may be made without departing from the scope of the present invention.

What is claimed is:

1. A plastic film comprising:
a first plastic layer;
a printed layer connected to an inside of the first plastic layer, and
a second plastic layer connected to the inside of the first plastic layer to sandwich the printed layer between the first and second plastic layers.

2. The plastic film as claimed in claim 1, wherein the first plastic layer is made of Polyethylene Terephthalate and the second plastic layer is made of Polyvinylchoride, a glue layer is applied between the first and second plastic layers, the first and second plastic layers are connected to each other by way of high frequency heating or ultrasonic heating.
